(19) United States
(12) Patent Application Publication
(10) Pub. No.: US 2019/0279508 A1
(43) Pub. Date: Sep. 12, 2019

(54) SYSTEMS AND METHODS OF INTER-VEHICLE COMMUNICATION

(71) Applicant: SF Motors Inc., Santal Clara, CA (US)

(72) Inventor: Chongyu WANG, Santa Clara, CA (US)

(21) Appl. No.: 15/914,471

(22) Filed: Mar. 7, 2018

(51) Int. Cl. G08G 1/0967; H04W 4/46; H04W 4/80; G08G 1/04; G01S 19/42

(52) U.S. Cl. CPC G08G 1/096725; H04W 4/46; G08G 1/096791; H04N 7/18; G08G 1/04; G01S 19/42; H04W 4/80

(57) ABSTRACT

Provided herein are systems and methods of inter-vehicle communication to navigate road conditions. A data processing system (DPS) of a first vehicle can identify a stop condition of the first vehicle at a road condition that includes an all-way stop, and a corresponding first time instance based on a time source of a positioning component. A transceiver can broadcast the first time instance. The DPS can monitor for a second time instance that indicates a stop condition of a second vehicle to identify a monitored result. The DPS can compare the first time instance to the monitored result to determine an order of passage through the road condition. The DPS can provide, based on the order of passage, a command to ECU(s) to initiate motion of the first vehicle. The transceiver can broadcast a third time instance that corresponds to the initiation of the motion of the first vehicle.

### BACKGROUND

Vehicles such as automobiles can include mechanisms to gather information related to vehicle operation or to the environment of the vehicle. This information can indicate a status of the vehicle or environment conditions for autonomous driving.

### SUMMARY

The present disclosure is directed to systems and methods for communication between vehicles at intersections. The disclosed system and methods can allow for interaction, communication or coordination between vehicles at an intersection to determine a priority or turn for each vehicle to drive across the intersection or perform a turn at the intersection. The disclosed system and methods can for example be incorporated into self-driving advanced driving assistance systems. Cities in some countries, such as US, Canada and South Africa, use all-way stops or intersections (hereafter sometimes generally referred to as intersections or stops), which typically indicate that traffic approaching from all directions should stop before proceeding through the intersection. The disclosed system and methods can provide an intelligent mechanism to coordinate, direct or optimize vehicle behavior at intersections, by using on-board sensors and map data for instance.

At least one aspect is directed to a system for inter-vehicle communication to navigate road conditions. The system can include a data processing system of a first vehicle. The data processing system can include an arbitration component, a positioning component, a transceiver, and one or more electronic control units (ECUs). The data processing system can identify a stop condition of the first vehicle at a road condition that includes an all-way stop, and a first time instance that corresponds to the stop condition, the first time instance identified based on a time source of the positioning component. The data processing system can broadcast, via the transceiver, a first data transmission from the first vehicle at the all-way stop, the data transmission indicating the first time instance. The data processing system can monitor for a second time instance that indicates a stop condition of a second vehicle at the all-way stop to identify a monitored result. The data processing system can compare, using the arbitration component, the first time instance to the monitored result to determine an order of passage through the road condition. The data processing system can provide, based on the order of passage through the road condition, a motion command from the arbitration component to the one or more ECUs to initiate motion of the first vehicle through the road condition. The data processing system can broadcast, via the transceiver, a second data transmission that includes a third time instance that corresponds to the initiation of the motion of the first vehicle through the road condition, the third time instance identified based on the time source of the positioning component.

At least one aspect is directed to a method of inter-vehicle communication to navigate road conditions. A data processing system of a first vehicle can include an arbitration component, a positioning component, a transceiver, and one or more electronic control units (ECUs). The data processing system can be configured to identify a stop condition of the first vehicle at a road condition that includes an all-way stop, and a first time instance that corresponds to the stop condition, the first time instance identified based on a time source of the positioning component. The transceiver can broadcast a first data transmission from the first vehicle at the all-way stop, the data transmission indicating the first time instance. The data processing system can monitor for a second time instance that indicates a stop condition of a second vehicle at the all-way stop to identify a monitored result. The arbitration component can compare the first time instance to the monitored result to determine an order of passage through the road condition. The data processing system can provide, based on the order of passage through the road condition, a motion command from the arbitration component to the one or more ECUs to initiate motion of the first vehicle through the road condition. The transceiver can broadcast a second data transmission that includes a third time instance that corresponds to the initiation of the motion of the first vehicle through the road condition, the third time instance identified based on the time source of the positioning component.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts a block diagram depicting an example system of inter-vehicle communication;

FIG. 2 depicts an example of inter-vehicle communication at a road condition;

FIG. 3 depicts an example functional diagram of inter-vehicle communication;

FIG. 4 depicts a flow diagram depicting an example method of inter-vehicle communication; and

FIG. 5 is a block diagram depicting a general architecture for a computer system that can be employed to implement elements of the systems and methods described and illustrated herein.

### DETAILED DESCRIPTION

Following below are more detailed descriptions of various concepts related to, and implementations of, methods, apparatuses, and systems of communication between vehicles at intersections. The various concepts introduced above and discussed in greater detail below may be implemented in any of numerous ways.

Described herein are systems and methods of inter-vehicle communication at road conditions such as intersections. The disclosed system and methods can allow for interaction, communication or coordination between vehicles at an intersection to determine a priority, a turn or a time for each vehicle to drive across the intersection or to perform a turn at the intersection. Certain disclosed implementations can use a front-facing camera or stored map data of a vehicle to identify an all-way stop or intersection for instance, and allow the vehicle to communicate with any neighboring vehicles at or near the intersection, and to provide information about when the vehicle has stopped at the intersection and when the vehicle is initiating motion from the intersection, using a time source synchronized between these vehicles. By sharing such information between vehicles, the vehicles can systematically determine a sequence for the vehicles to navigate the intersection in turn while avoiding contention and accident.

The disclosed solutions have a technical advantage relative to any system that would instead rely solely on onboard imaging technology to for example detect if other vehicles at an intersection are moving or not before deciding to move its host vehicle. For example, an exclusive or over reliance on imaging technology can be inaccurate because of poor visibility due to low light, obstructions, or weather conditions such as rain or white-out conditions during a snow storm. Moreover, the detection of whether the other vehicle is stationary does not accurately predict if the other vehicle is about to initiate motion or may initiate motion at around the same time as the host vehicle. Furthermore, for two vehicles that each rely on imaging technology to halt itself upon detecting motion in the other, such a purely reactive mechanism could lead to scenarios where instances of contention, or the reaction times for detecting motion or braking, can cause inefficiencies in getting traffic through an intersection as compared to the present solutions where vehicles can coordinate between themselves without ambiguity by using synchronized time sources to provide a time reference for comparing vehicle stop times to determine priority between vehicles. The amount of resources (e.g., bandwidth, computational resources, energy consumption) for receiving and comparing timestamps in the present solutions are also substantially less than that for the aforementioned imaging-based approaches, which rely on essentially continuous imaging and image processing to detect vehicles and their motion.

On board vehicle image based systems that determine conditions or status of other vehicles (e.g., in motion or stopped when at or approaching an intersection) may continuously or near-continuously record their surroundings to detect other vehicles and determine their conditions when at or near intersections. The recording requirements of image-based systems can require substantial power and memory usage, significant bandwidth capacity for transmission of the images, and significant processing power for processing of the images (e.g., to determine if or when the vehicle has stopped). Such systems for vehicle navigation may have difficulty to efficiently acquire, transmit, or process data packets that include information about the motion or stop conditions of neighboring or proximate vehicles at or approaching an intersection (or other road conditions). The data processing system described herein can improve the efficiency and effectiveness of information acquisition and transmission over one or more types of computer networks between vehicles. For example, by identifying a vehicle stop time of the vehicle associated with the data processing system, transmitting this stop time to other vehicles, and receiving stop time information from other vehicles, the data processing system described herein reduces on-board data acquisition, storage, power, internal bandwidth, and processing requirements relative to image-reliant systems. Even when the recording of image based systems to determine vehicle stop conditions is not continuous, the amount of data collected for this purpose via recording remains significant relative to a time-based approach where an accurate time signal is obtained at the moment of vehicular stoppage at an intersection and then the time signal (e.g., with associated information), transmitted to other vehicles at or near (e.g., within 1000 feet) of the intersection, and similar signals are received from other vehicles. This reduces the amount of data stored in memory and data processing that occurs in the on-board data processing system described herein, which saves memory requirements and power usage, and results in computational efficiency.

The disclosed solutions also have a technical advantage relative to human-operated intersection navigation. For instance, human drivers rely on sight (in some respects similar to the imaging technology described above), to determine the state of other vehicles, and is similarly subject to constraints under poor visibility conditions. Hand, facial or body gestures or cues to signal intentions between human operators can be limited or impossible under poor visibility conditions such as at night or during poor weather. Furthermore, such cues and gestures often appear ambiguous, or are often conveyed unsuccessfully or inefficiently due to other drivers' inattentiveness, distance or limited visibility. In a standard or autonomous driving context, human intervention can be irrelevant or unavailable. In contrast, the technical solutions described herein do not rely on human intervention, and can use wireless communication protocols that are robust against low visibility conditions and weather conditions, to share information between vehicles. The shared information (e.g., on specific timestamps for each vehicle to come to a halt at the intersection) is concise and can be used to systematically, unambiguously and consistently determine a priority or sequence for traversing the intersection, using first-in-first-out (FIFO) rules configured or programmed in each vehicle. Such a determination can be performed independently by each vehicle using the shared information, and be consistent between the vehicles. The synchronized time sources used in the present solutions can have an accuracy level sufficient to distinguish between the stop times of vehicles in almost all cases, which can avoid contention and ambiguity that would otherwise exist in alternative mechanisms for navigating an intersection.

The disclosed system and methods can be incorporated into self-driving advanced driving assistance systems, in vehicles such as electric vehicles (EVs) or autonomous driving vehicles. EVs can include electric automobiles, cars, motorcycles, scooters, passenger vehicles, passenger or commercial trucks, and other vehicles such as sea or air transport vehicles, planes, helicopters, submarines, boats, or drones. EVs can be fully autonomous, partially autonomous, or unmanned. Fully autonomous, partially autonomous or unmanned vehicles can include non-electric vehicles such as vehicles based on combustion engines or non-electric engines.

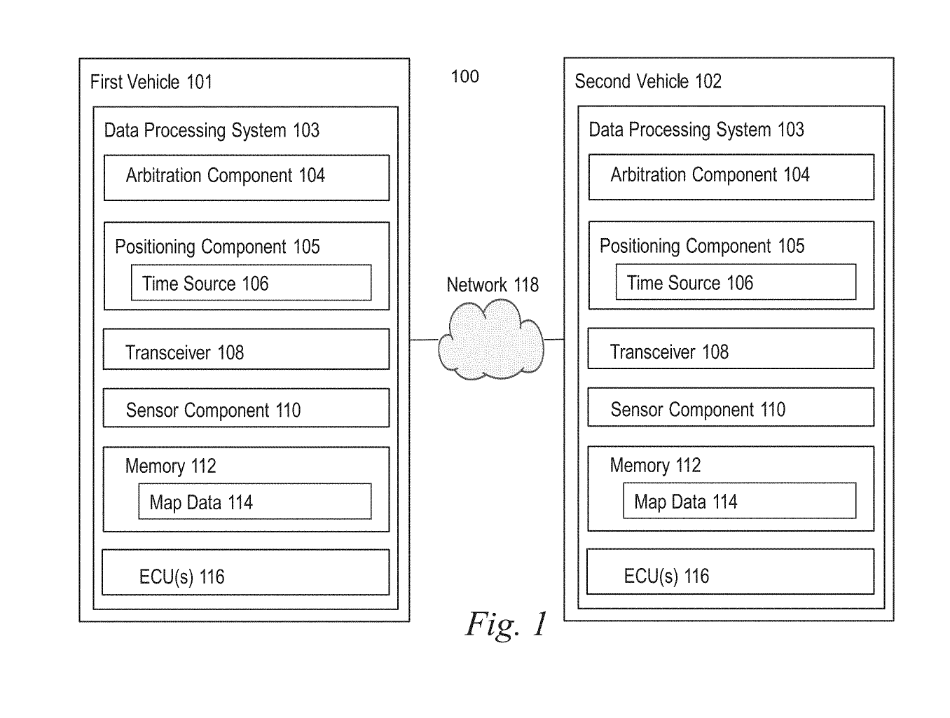

Referring to FIG. 1, among others, depicted is an example system 100 of inter-vehicle communications. The system 100 can include at least one data processing system 103 for use in communication between vehicles at an intersection for instance. The data processing system 103 can include at least one arbitration component 104, at least one positioning component 105 with at least one time source 106, at least one transceiver 108, at least one sensor or sensor component 110, at least one memory 112 to store map data 114 or other data for instance, and at least one electronic control unit (ECU), among other components. The data processing system 103 can include hardware or a combination of hardware and software, such as communications buses, circuitry, processors, communications interfaces, among others. Each data processing system 103 can reside on or within a corresponding vehicle (e.g., a host vehicle). For instance, FIG. 1 shows a first vehicle 101 with a data processing system 103 on-board, and a second vehicle 102 with another or similar data processing system 103 on-board. Each of the first vehicle 101 and the second vehicle 102 (or their corresponding data processing system 103) can be communicatively connected to a network 118 to each other or to one or more other systems (e.g., a global positioning system, or to one or more communications devices).

Each of the components of the data processing system 103 can be implemented using hardware or a combination of software and hardware. Each component of the data processing system 103 can include logical circuitry (e.g., a central processing unit or CPU) that responses to and processes instructions fetched from a memory unit (e.g., memory 112). Each component of the data processing system 103 can include or use a microprocessor or a multi-core processor. A multi-core processor can include two or more processing units on a single computing component. Each component of the data processing system 103 can be based on any of these processors, or any other processor capable of operating as described herein. Each processor can utilize instruction level parallelism, thread level parallelism, different levels of cache, etc.

For instance, the data processing system 103 can include at least one logic device such as a computing device or server having at least one processor to communicate via the network 118. A data processing system 103 of the first vehicle 101 can communicate with a different data processing system 103 that is associated with or part of a second vehicle 102. The data processing system 103 can initiate a vehicle stop notification based on timing information associated with the first vehicle 101 coming to a complete stop, can broadcast or otherwise transmit this notification to one or more vehicles, detect time instances of stop notifications received from one or more vehicles, provide start motion notifications, and can broadcast or otherwise transmit the start motion notifications to one or more other vehicles. The arbitration component 104, positioning component 105, time source 106, transceiver 108, sensor 110, memory 112, and map data 114 can each include at least one processing unit, server, virtual server, circuit, engine, agent, appliance, or other logic device such as programmable logic arrays configured to communicate with the vehicle (e.g., first vehicle 101) that includes the data processing system as well as with other vehicles (e.g., second vehicle 102) via the network 118.

The network 118 can include computer networks such as the internet, local, wide, near field communication, metro or other area networks, as well as satellite networks or other computer networks such as voice or data mobile phone communications networks, and combinations thereof. The network 118 can include or constitute an inter-vehicle communications network, e.g., a subset of components including the data processing system 103 and components thereof for inter-vehicle data transfer. The network 118 can include a point-to-point network, broadcast network, telecommunications network, asynchronous transfer mode network, synchronous optical network, or a synchronous digital hierarchy network, for example. The network 118 can include at least one wireless link such as an infrared channel or satellite band. The topology of the network 118 can include a bus, star, or ring network topology. The network 118 can include mobile telephone or data networks using any protocol or protocols to communicate among vehicles or other devices, including advanced mobile protocols, time or code division multiple access protocols, global system for mobile communication protocols, general packet radio services protocols, or universal mobile telecommunication system protocols, and the same types of data can be transmitted via different protocols.

The components and elements of the data processing system 103 can be separate components, a single component, or part of the data processing system 103. For example, the arbitration component 104, the positioning component 105, and the sensor 110 (and the other elements of the data processing system 103) can include combinations of hardware and software, such as one or more processors configured to initiate stop commands, initiate motion commands, and transmit or receive timing data, for example.

The components of the data processing system 103 can be hosted on or within a single vehicle, such as an EV. However, some components of the data processing system 103 (e.g., memory 112 with map data 114) can reside outside of the vehicle, and be in communication with the vehicle for at least a certain time period. For example, the memory 112 can reside on a remote server, such as in a cloud of servers, that maintains the map data 114, and can be accessed by the data processing system 103 (e.g., through network 118) at times when the map data 114 is obtained to identify a location of the host vehicle or an intersection for instance. The components of the data processing system 103 can be connected or communicatively coupled to one another. The connection between the various components of the data processing system 103 can be wired or wireless, or any combination thereof. Counterpart systems or components can be hosted on other vehicles to enable communication or coordination between vehicles.

The disclosed system and methods can provide an intelligent mechanism to coordinate, direct or standardize the operation or behavior of each vehicle at an intersection, by using onboard sensors and inter-vehicle communication for instance. Although the disclosure can sometimes refer to an intersection as an all-way stop for on-road automobile traffic, this is merely by way of illustration and not intended to be limiting in any way. For example, other road conditions including other types of intersections, for waterways, airways, in space or otherwise, that can involve coordination, arbitration or negotiation between vehicles to navigate, are included.

An intersection can include an intersection involving traffic of any number of directions, such as a 2-way, 3-way, 4-way or 5-way intersection. The intersection can include one or more signs or other indicators, visual or otherwise, for traffic to stop or halt, before proceeding into the intersection for instance. The intersection can allow a vehicle to make any type of turn (e.g., left or right turn, from slight to sharp turn, anywhere between 0 and 180 degrees in angle, where appropriate or legal), or to proceed across an intersection. The intersection can include one or more signs or other indicators, visual or otherwise, to indicate where a vehicle should stop or halt from motion. In some cases, the present system and methods can be used in intersections where there is zero or limited traffic control (e.g., absence of a traffic police or traffic control lights, or unavailable, malfunctioning, or inactive traffic control lights). In this disclosure, an all-way stop refers to an intersection that requires an approaching vehicle to make a stop (e.g., at specified spots, markers or locations) before proceeding into the intersection (e.g., to make a turn or cross the intersection).

The sensor 110 of the data processing system 103 can include one or more sensing elements or transducers that captures, acquires, records or converts information about its host vehicle or the host vehicle's environment into a form for processing. The sensor 110 can acquire or detect information about road conditions such as an intersection or an all-way stop. The sensor 110 can detect a road condition such as a road feature, boundary, intersection, lane corridor, or other condition. The sensor 110 can for example acquire one or more images of the intersection, which can be processed using image processing and object recognition to identify or detect features indicative of an intersection, e.g., a stop sign or surface markings on a street or road. For instance, the sensor 110 can acquire one or more images or recordings (e.g., photographic, radar, ultrasonic, millimeter wave, infra-red, ultra-violet, audio, or video). The sensor 110 can communicate an acquired image or recording to a data processor (e.g., of one of the ECUs 116 or arbitration component 104) for processing, which can include filtering, noise reduction, image enhancement, etc., followed by object recognition or feature detection. The data processor can parse image information sensed by the sensor 110 to determine the presence of an intersection (or other road condition). The data processor can for instance match or map one or more objects or features detected from the processing, to known objects or features (e.g., a stop sign, or markings on a traffic lane, corresponding to an intersection or all-way stop) stored in a database (e.g., memory 112). The data processor can, based on at least such a match to a known object or feature, determine that the acquired image or recording corresponds to an intersection or all-way stop, and can output a result accordingly. For example, the arbitration component 104 of the first vehicle 101 can determine that the first vehicle 101 is at or approaching an intersection or all-way stop, based at least on the output of the data processor, map data, location data of the first vehicle 101, or markers or indicators at the intersection (that can be sensed by a vehicle-to-infrastructure (V2I) sensor of the sensor 110. The arbitration component 104, which can issue a stop command that can cause the ECU(s) 116 to cause the first vehicle 101 to stop at the intersection. Via the transceiver 108, the arbitration component 104 or ECU(s) 116 can issue an instruction to broadcast (or to transmit via a dedicated communication channel to a known recipient) a timestamp that indicates a time that the first vehicle 101 stopped at the intersection.

The sensor 110 can include a camera as well as one or more sensors of one or more types. For example, the sensor 110 can include a Radar, light detection and ranging (LIDAR), ultrasonic, or vehicle-to-everything (V2X) (e.g., vehicle-to-vehicle (V2V), V2I, vehicle-to-device (V2D), or vehicle-to-passenger (V2P)) sensor, that can be used to detect an approaching intersection. For instance, a part of the intersection can be installed with a radio-frequency identification (RFID) or other marker or indicator (e.g., on or within a stop sign, pavement, traffic light, or other dedicated structure), which can provide visual or other characteristics (e.g., electromagnetic, audio or other emissions. The data processor, interoperating with the sensor 110, can capture, sense, detect or recognize such characteristics, so that the data processing system 103 can determine that the intersection is present or approaching relative to the motion of a host vehicle.

The sensor 110 can include a global positioning system (GPS) device that can determine a location of the host vehicle relative to an intersection, using map data 114 with an indication of the intersection for instance. The GPS device can use the map data to determine that the host vehicle has reached the intersection, e.g., reached a “stop” marker on a street at which the vehicle should halt. The sensor 110 can also detect (e.g., using motion sensing, imaging or any of the other sensing capabilities described herein) whether any other vehicle is present at or approaching the intersection, and can track any such vehicle's position or movement over time for instance.

The ECU 116 of the data processing system 103 can be an embedded system that controls one or more of the electrical system or subsystems in a transport vehicle. The arbitration component 104 can include or be part of one or more electronic control units (ECUs) 116, such as a telematics ECU. The arbitration component 104 can manage, control or send instructions to one or more ECUs 116. An ECU is sometimes referred to as an automotive computer, and can include a processor or microcontroller, memory, embedded software, inputs/outputs and communication link(s). An ECU involves hardware and software to perform the functions expected from that particular module. For example, types of ECU include Electronic/engine Control Module (ECM), Powertrain Control Module (PCM), Transmission Control Module (TCM), Brake Control Module (BCM or EBCM), Central Control Module (CCM), Central Timing Module (CTM), General Electronic Module (GEM), Body Control Module (BCM), Suspension Control Module (SCM), control unit, or control module. Other examples include domain control unit (DCU), Electric Power Steering Control Unit (PSCU), Human-machine interface (HMI), Telematic control unit (TCU), Speed control unit (SCU), Battery management system (BMS). For example, the arbitration component 104 of a first vehicle 101 can instruct a BCM to stop the first vehicle 101 at an intersection, can instruct a TCU identify a location of the first vehicle 101, e.g., relative to stored map data 114, and can instruct a TCM or ECM to move the first vehicle 101 from a stop.

The arbitration component 104 can include or execute at least one computer program or at least one script, and can include hardware or a combination of hardware and software, such as one or more ECUs. The arbitration component 104 can be in communication with the sensor 110, for instance to process information acquired, sensed or imaged by the sensor 110. By using an image or video processor to process the information from the sensor 110, the arbitration component 104 can determine that its host vehicle has reached or is approaching an intersection for instance. The arbitration component 104 can control or manage the sensor 110 (e.g., through a vehicle onboard interface, gateway, switch or network), so as to instruct the sensor 110 to acquire an image (e.g., of an intersection) in front of or around its host vehicle for processing, to verify that the image is consistent with stored map data. The arbitration component 104 can instruct the ECU(s) 116 to reduce the speed of its host vehicle to initiate a stop at an all-way stop for example, responsive to detecting the all-way stop. The arbitration component 104 can initiate the stop by instructing or controlling one or more ECUs such as a BCM or a TCM, which can in turn control or activate the brakes or a transmission module of the host vehicle. The arbitration component 104 can determine, according to timing information provided by the positioning component 105 for instance, a time instance at which the host vehicle completed the stop at the intersection. The arbitration component 104 can use the time source 106 of the positioning component 105 to determine or identify the time instance at which the host vehicle completed the stop at the intersection. The positioning component 105 can determine or identify the time instance at which the host vehicle completed the stop at the intersection, by accessing an output of the time source 106 when triggered by an onboard gyroscope or wheel-movement sensor for instance. The positioning component 105 can provide the determined time instance to the arbitration component 104. The arbitration component 104 can, via the transceiver 108 can transmit this information to other potential vehicles (e.g., the second vehicle 102) that are at, in, or approaching (e.g., within 1000 feet of) the intersection.

The arbitration component 104 can compare timestamps between multiple vehicles (e.g., the first vehicle 101 and the second vehicle 102) at the intersection. By comparing the timestamps between vehicles at the intersection, the arbitration component 104 can determine an order (e.g., the first vehicle 101, followed by the second vehicle 102) by which the vehicles can proceed into or through the intersection. The arbitration component 104 can also notify other vehicles of its host vehicle's movement into the intersection (e.g., by causing the transceiver 108 to transmit a timestamp of the host vehicle's movement into the intersection), and track other vehicles' movement into the intersection (e.g., by causing the sensor 110 to acquire imagery, and an ECU 116 to process the acquired imagery and detect movement of other vehicles in the imagery), according to timing information relative to the time source 106. This enables the movements of vehicles at the intersection to be coordinated. In some implementations, the data processing system 103 can receive (e.g., via the transceiver 108), confirmation from other vehicles that they have received the transmitted timestamp.

The memory 112 of the data processing system 103 can store or maintain information such as map data 114. The map data 114 can be used with the positioning component to indicate or confirm a location of the host vehicle, e.g., that the host vehicle is at or approaching an intersection defined in the map data 114. The memory 112 can hold or buffer images or data acquired by the sensor 110 for further processing. The memory 112 can hold or buffer information or messages communicated via the transceiver 108. For example, the memory 112 can hold or store information received from other vehicles, such as time instances at which other vehicles come to a stop at the intersection.

The memory 112 can include various types of memory, such as one or more memory chips capable of storing data and allowing any storage location to be directly accessed by a processor. The memory 112 can be volatile and faster than storage memory. The memory 112 can be Dynamic random access memory (DRAM) or any variants, including static random access memory (SRAM), Burst SRAM or SynchBurst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). The central processing unit.

The positioning component 105 can include or execute at least one computer program or at least one script, and can include receivers or sensors for receiving signals from a positioning system, and can include circuitry and software for processing the received signals. The positioning component 105 can include elements from one or more sensors 110 or ECUs 116. The positioning component 105 can include any device based on a positioning system such as Global Navigation Satellite System (GNSS), which can include GPS, GLONASS, Galileo, Beidou and other regional systems. The time source 106 can include a device that generates, provides or is synchronized to a time reference obtained from the positioning component 105. The time source 106 can correspond to timing or time reference obtained from the GPS satellite positioning system for example. A satellite associated with the positioning component 105 can carry an on-board atomic clock, accurate to one second in 400 million years for instance, which can be synchronized to a master atomic clock located in a base station on Earth. The time source 106 can obtain or process timing signals based on the on-board atomic clock, that are transmitted from such a satellite. The time source 106 can use the timing signals to provide time that is accurate to sub-microsecond levels or even to picoseconds for example. The arbitration component 104 can thus determine a time instance for an event (e.g., a time instance at which the host vehicle completed the stop at the intersection), to an accuracy of at least less than a microsecond. Each vehicle hosting its own time source 106 would also be synchronized to an accuracy level below a microsecond between themselves.

The positioning component 105 can include a positioning system based on a telecommunications or cellular (e.g., 3G, 4G, 5G) communications network (e.g., network 118), which can have a master clock that is synchronized to GPS timing for instance. The corresponding time source 106 can provide time that is accurate to sub-microsecond levels, such as 0.2 or 0.5 microsecond. For example, the time source 106 can provide a vehicle stop time of its host vehicle that is accurate to a tolerance range of 0.1 to 0.2 microseconds, or less than one microsecond. The time source 106 can provide a start time for moving the host vehicle out of a stop, that is accurate to a defined tolerance range, such as 0.1 to 0.2 microseconds, or 0.2 to 0.5 microseconds. The time source 106 can operate (e.g., run a clock locally onboard the host vehicle) for periods of time that the time source 106 is offline from the network 118 for instance, and be synchronized with timing signals from the network 119 when the time source 106 is back online with the network 118. The time source 106 can receive timing signals from the network 119 in real time or at certain intervals to synchronize with the network's master clock.

The transceiver 108 can include one or more than one transceiver, as well as separate or independent transmitter and receiver components. The transceiver 108 can include receive and transmit chains for wireless communication, that include one or more filters, amplifiers, frequency up/downconverters, mixers, clock sources, analog/digital converters, antennas, among others. The transceiver 108 can send or broadcast messages or communications from its host vehicle, to other vehicles via the network 118 for instance. The arbitration component 104 can use or instruct the transceiver 108 to send or broadcast a message comprising a time instance for an event (e.g., time instance at which the host vehicle completed the stop at an all-way stop, or time instance at which the host vehicle initiated motion from the all-way stop). The transceiver 108 can send a message to another vehicle wirelessly using one or more communications protocols, such a communication protocol based on vehicle-to-vehicle (V2V) communications, wireless local area network (WLAN) or wireless fidelity (WiFi, e.g., any variant of IEEE 802.11 including 802.11a/b/g/n), wireless personal area network (WPAN, e.g., Bluetooth, Zigbee, ultra-wideband (UWB), WiMedia, Wibree, wireless universal serial bus, ONE-NET), cellular (e.g., CDMA/CDMA2000, GSM/UMTS, UMTS over W-CDMA, UMTS-TDD, LTE, 3G/4G/5G, and so on), wireless metropolitan area network WIMAN (e.g., WiMax), and other wide area network, WAN technologies (e.g., iBurst, Flash-OFDM, EV-DO, HSPA, RTT, EDGE, GPRS), LoRa, infrared (IR), radio frequency identification (RFID), satellite or geographical positioning system, optical (e.g., lightwave transmission, laser), ultrasonic, dedicated short range communications (DSRC), near field communication (NFC), radar, and so on, though not limited to these. The transceiver 108 can send a message to another vehicle using a direct peer-to-peer (P2P) connection, or through a communication network. The transceiver 108 can send the message as a broadcast to a plurality of vehicles in the vicinity, or as a message addressed to identified vehicle(s).

The communication protocol(s) selected for communicating messages between vehicles can depend on environmental conditions. For example, to ensure a robust or stable communication channel between vehicles under certain severe weather or low-visibility conditions, a cellular-based communication protocol can be used for example, instead of some other communication protocols. Alternatively, two or more modes of wireless communications (e.g., cellular and NFC) can be employed (e.g., in parallel or sequentially) for redundancy to ensure that a message can be conveyed successfully to other vehicles.

The transceiver 108 can receive a message from another vehicle wirelessly using one or more communications protocols, in any manner described herein. The arbitration component 104 can receive or detect, using the transceiver 108, a message comprising a time instance at which another vehicle completed a stop at the intersection, or a time instance at which another vehicle initiated motion from the intersection.

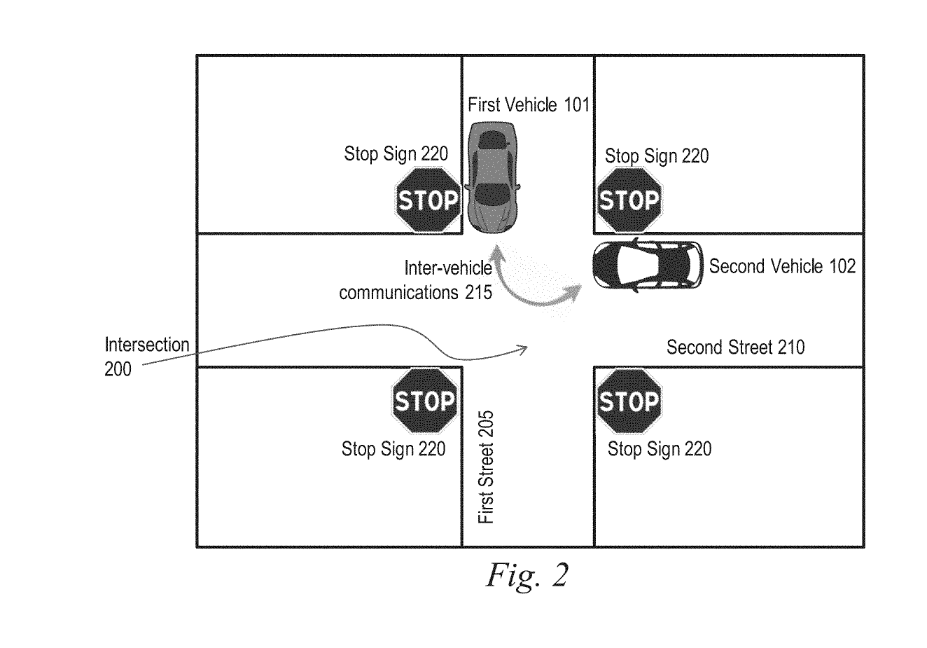

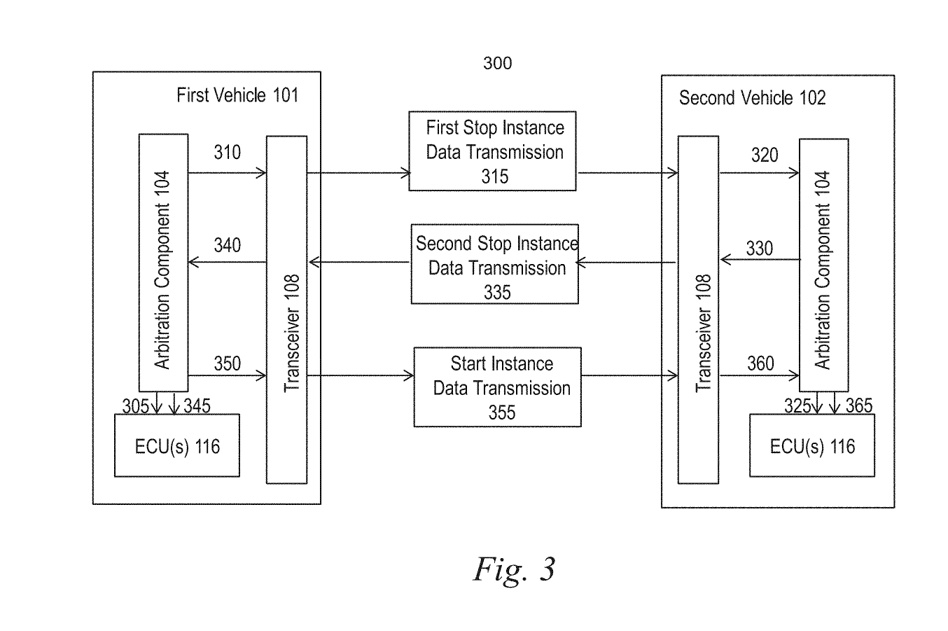

FIG. 2, for example, depicts one possible scenario of two vehicles at an intersection 200. However, such a scenario can be extended to any number of vehicles at any type of intersection or other road condition such as a merger, on-ramp, off ramp, yield, traffic light, detour, or other road condition or event. A first vehicle 101, for example, can arrive at an intersection 200 while traveling on or along a first street 205. A second vehicle 102 can arrive at the intersection 200 while traveling on or along a second street 210. The first street 205 and the second street 210 can cross or intersect at the intersection 200, which can include an all-way stop. One or more corners or locations of the intersection 200 can include at least one stop sign 220 or any other markers as described herein. One of the two vehicles, for example the first vehicle 101, can arrive at the intersection 200, and stop at or before a stop sign 220 of the intersection 200 along the first street 205 prior to the second vehicle 102 stopping at or before another stop sign 220 at the intersection 200 along the second street 210. Each of the vehicles can detect the intersection 200 using their on-board sensor 110, positioning component 105 or map data 114 for example, as disclosed in connection with at least FIG. 1 for instance. The first vehicle 101 and the second vehicle 102 can coordinate their turn(s) or pass-through(s) at the intersection 200 using inter-vehicle communications 215 as disclosed herein, for example, in connection with at least FIG. 3.

FIG. 3, for example, depicts an example functional diagram of an environment 300 of inter vehicle communication. The environment 300 can include a flow or sequence of actions performed by vehicles or associated data processing systems 103 at an intersection 200 (or other road condition or event). The actions can include data transmissions (e.g., 315, 335, 355) each of which can be transmitted via one or more communications protocols (e.g., cellular based protocol(s) or NFC), and can be stored in memory 114 of the first vehicle 101 or second vehicle 102, for example prior to transmission at the corresponding vehicle and after receipt by a respective vehicle. FIG. 3 depicts a first vehicle 101 and a second vehicle 102 (any number of vehicles are possible) as in FIG. 1 among others. The vehicles 101, 102 can each include at least one data processing system 103 and components thereof. The first vehicle 101 and the second vehicle 102 can arrive at and stop at the intersection 200 as discussed in connection with at least FIG. 2 for example.

Each vehicle (e.g., first vehicle 101, second vehicle 102), can communicate their respective stop times to each other. For example, an arbitration component 104 of first vehicle 101 can initiate a stop for the first vehicle 101 at the intersection 200 by sending an instruction (ACT 305), e.g., a first vehicle command instruction, to the ECU(s) 116 to apply brakes of the first vehicle 101 for instance. The vehicle command instruction and other instructions described herein can include packet or other protocol based instructions, and be transmitted in packets, frames or other types of messages (hereafter generally referred to as packets). For instance, a packet can have payload and header. The header can for example identify a destination (e.g., an ECU 116 of the first vehicle 101). The packet's payload can for example include commands such as commands to apply brakes. Upon the first vehicle 101 coming to a stop at the intersection 200, the arbitration component 104 of the first vehicle 101 can obtain from a timing reference or clock reference of a time source 106 of the first vehicle 101, a first time instance (e.g., as a first timestamp) at the instance the first vehicle 101 completed the stop (first stop instance) for example. Similarly, other time instances or timestamps that each corresponds to a specific occurrence or condition can be obtained by the arbitration component 104 from the time source 106 of the respective host vehicle at the instance of the corresponding occurrence or condition.

The arbitration component 104 can send at least one instruction (ACT 310), e.g., a first transceiver command instruction, with the first time instance to the transceiver 108 of the first vehicle 101, to broadcast a first message (also referred as a first stop instance data transmission 315) including the first time instance. The transceiver 108 can transmit or broadcast the first message based on the instructions, in the at least one first stop instance data transmission 315. The transceiver 108 can transmit or broadcast the first stop instance data transmission 315 using, for example packet or other protocol based data transmissions, through the network 118. A transceiver 108 of the second vehicle 102 at the intersection 200 can receive the first message. The transceiver 108 of the second vehicle 102 can convey the received first message to the arbitration component 104 of the second vehicle 102 (ACT 320). The arbitration component 104 of the second vehicle 102 can use or instruct a processor or ECU of the arbitration component 104 to process the first message, e.g., to extract the first time instance from the first message.

The arbitration component 104 of the second vehicle 102 can at a certain time, initiate a stop (or other action) for the second vehicle 102 at the intersection 200 by sending an instruction (e.g., a second vehicle command instruction) to the ECU(s) 116 of the second vehicle 102 (ACT 325) to apply brakes of the second vehicle 102 for instance. Upon the second vehicle 102 coming to a stop at the intersection 200, the arbitration component 104 of the second vehicle 102 can obtain from a time source 106 of the second vehicle 102, a first time instance (e.g., as a second timestamp) corresponding to the stop by the second vehicle 102 (second stop instance). The arbitration component 104 of the second vehicle 102 can an instruction (e.g., a second transceiver command instruction) with the second time instance to the transceiver 108 of the second vehicle 102 (ACT 330), to broadcast a second message (also referred as a second stop instance data transmission 335) including the second time instance. The transceiver 108 of the second vehicle 102 can transmit or broadcast the second stop instance data transmission 335 (or other message having vehicle related information). The transceiver 108 of the second vehicle 102 can transmit or broadcast the second message using any of the communications protocols discussed herein, through the network 118 for instance. The transceiver 108 of the first vehicle 101 can receive the second message. The transceiver 108 of the second vehicle 102 can convey the received second message to the arbitration component 104 of the second vehicle 102 (ACT 340). The arbitration component 104 of the second vehicle 102 can use or instruct a processor or ECU of the arbitration component 104 to process the second message, e.g., to extract the second time instance from the second message.

The first vehicle 101 and the second vehicle 102 can wait to receive the other vehicle's stop time, and then the respective data processing systems 103 can compare the respective stop times (from data transmissions 315 and 335) to determine which vehicle should proceed first from the intersection 200. The arbitration component 104 of each vehicle can compare the first time instance at which first vehicle 101 completed its stop, and the second time instance at which second vehicle 102 completed its stop at the intersection. The arbitration component 104 of each vehicle can be configured to determine (e.g., independently from the arbitration component 104 of the other vehicle) a temporal order in which the first vehicle 101 and second vehicle 102 completed their respective stops at the intersection, and determine a corresponding order or sequence for the vehicles to initiate motion from the intersection. Each arbitration component 104 can assign a turn or time for each vehicle to move from the intersection, according to the sequence or times at which the vehicles completed their stops. For instance, because the first vehicle 101 completed its stop prior to the second vehicle 102, the first vehicle 101 can start or begin motion from the intersection 200 ahead of the second vehicle 102, in accordance with the determined order or sequence. The arbitration component 104 of the second vehicle 102 can maintain or send one or more instructions for the ECU(s) 116 of the second vehicle 102 to maintain the second vehicle's stop at the intersection 200, in accordance with the determined order or sequence.

The arbitration component 104 of the first vehicle 101 can send one or more instructions (e.g., a third vehicle command instruction) to the ECU(s) of the first vehicle 101 to initiate motion (ACT 345), e.g., to engage the first vehicle 101's transmission, to cause an engine of the first vehicle 101 to apply a moving speed to the first vehicle 101, or to remove application of brakes for instance, to cause the first vehicle 101 to start or begin motion from the intersection. Upon the first vehicle 101 starting or beginning motion from the intersection 200, the arbitration component 104 of the first vehicle 101 can obtain from the time source 106 of the first vehicle 101, a third time instance (e.g., as a third timestamp) corresponding to the start instance by the first vehicle 101. The arbitration component 104 can send an instruction (ACT 350), e.g., a third transceiver command instruction, with the third time instance to the transceiver 108 of the first vehicle 101, to broadcast a third message (also referred as a start instance data transmission 355) or other notification or instruction. The transceiver 108 can transmit or broadcast the start instance data transmission 355. The transceiver 108 can transmit or broadcast the third message using any of the communications protocols discussed herein, through the network 118 for instance. The transceiver 108 of the second vehicle 102 at the intersection 200 can receive the third message. The transceiver 108 of the second vehicle 102 can convey the received third message to the arbitration component 104 of the second vehicle 102 (ACT 360). The arbitration component 104 of the second vehicle 102 can use or instruct a processor or ECU of the arbitration component 104 to process the first message, e.g., to extract the time instance from the third message.

The arbitration component 104 of the second vehicle 102 can, responsive to receiving or processing of the third message, determine that the first vehicle 101 has started motion from the intersection 200. Responsive to determining that the first vehicle 101 has started motion from the intersection, the arbitration component 104 of the second vehicle 102 can determine to maintain the second vehicle's stop at the intersection 200, for at least a defined period of time relative to the third time instance for example. For instance, the arbitration component 104 of the second vehicle 102 can maintain or send one or more instructions (e.g., a fourth vehicle command instruction) for the ECU(s) 116 of the second vehicle 102 to maintain the second vehicle's stop at the intersection 200, for at least a defined period of time (e.g., ACT 365). The defined period of time can for instance be in the range of 1-5 seconds, or any other value.

Upon expiration of the defined period of time for example, the arbitration component 104 of the second vehicle 102 can start or begin motion from the intersection 200, in accordance with the determined order or sequence. The arbitration component 104 of the second vehicle 102 can send one or more instructions to the ECU(s) of the second vehicle 102 to engage the second vehicle's transmission, to cause an engine of the second vehicle 102 to apply a moving speed to the second vehicle 102, or to remove application of brakes for instance, to cause the second vehicle 102 to start or begin motion from the intersection (e.g., ACT 365). Upon the second vehicle 102 starting or beginning motion from the intersection 200, the arbitration component 104 of the second vehicle 102 can obtain from a time source 106 of the second vehicle 102, a fourth time instance (e.g., as a fourth timestamp) corresponding to the start instance by the second vehicle 102. The arbitration component 104 can send instructions with the fourth time instance to the transceiver 108 of the second vehicle 102, to broadcast a fourth message including the fourth time instance, to any other vehicle that is still at or near the intersection 200. Accordingly, any other vehicle can operate according to the determined order or sequence, and in a similar manner as the first vehicle 101 or the second vehicle 102. For example, a transceiver 108 of a third vehicle stopped at the intersection can receive the fourth message. Responsive to the fourth message, an arbitration component 104 of the third vehicle can send one or more instructions to the ECU(s) 116 of the third vehicle to maintain the third vehicle's stop at the intersection 200, for at least the defined period of time. A transceiver 108 of the first vehicle 101 (if still within range of the broadcast of the fourth message) can receive the fourth message. However, the arbitration component 104 of the first vehicle 101 can ignore the fourth message because the first vehicle 101 should have cleared or left the intersection 200 by that time.

The third message (start instance data transmission 355) or fourth message can operate as a notification or warning to any other vehicles stopped at the intersection 200, as a safeguard against two or more vehicles concurrently moving in or into the intersection 200. The time instance conveyed in the third or fourth message can provide a time reference for a stopped vehicle to prepare the latter's subsequent motion. Upon receiving the notification or warning, the stopped vehicle can remain stationary for a certain period of time (e.g., a time period in the range of 2-5 seconds), to avoid interfering with the corresponding vehicle (e.g., first vehicle 101) that has moved into the intersection 200.

Since the time instances reported by each vehicle can be accurate to the level of sub-microseconds, the arbitration component 104 of each vehicle can determine the precise order at which the vehicles completed their stops at the intersection. There is a low probability that two or more vehicles would record the same time instance when subject to such an accuracy of the time source 106. In the rare situation where two or more vehicles would record the same time instance, the arbitration component 104 can apply one or more arbitration rules (e.g., stored in the memory 112, and configured to be consistent across vehicles) to establish an order for these vehicles. For example, the arbitration component 104 can order or prioritize the vehicles based on their vehicle identifiers (or other identifiers such as onboard device identifiers, license plate identifiers), presence or location of pedestrians crossing or intending to cross the intersection, or priorities established for each approaching direction of the intersection. Accordingly, the arbitration component 104 of each vehicle can systematically assign a turn or time for each vehicle to proceed from the intersection.

The arbitration component 104 can instruct one or more ECUs 116 to initiate motion of the host vehicle from the intersection according to the assigned turn or time to proceed from the intersection. The arbitration component 104 can, in communication with the sensor 110, use motion detection or imaging and object recognition for instance, to confirm that any other vehicle at the intersection are stationary, before initiating motion of the host vehicle. Any such imaging and object recognition can be limited to a defined time period (e.g., 1 or 0.5 seconds, or other time duration prior to initiating movement), to limit the amount of image processing. The motion detection or imaging and object recognition can occur while the arbitration component 104 is transmitting the host vehicle's stop time or determining the order of vehicles for instance, so as to minimize the vehicle's overall halt time at the intersection. This can improve the overall flow of traffic at an intersection.

Via the transceiver 108 and the network 118, the arbitration component 104 can transmit or broadcast a message with a time instance at which the host vehicle initiated motion from the intersection, to prevent any other vehicle stopped at the intersection from initiating motion (e.g., for at least a predefined period of time from the time instance). The message can include one or more packets formatted according to any of the communications protocols described herein. The message can be used to notify or warn the other vehicles, so as to avoid multiple vehicles from traversing the intersection at such proximity relative to each other as to potentially cause an accident or collision. The message can instruct the other vehicles to remain stopped, stationary or in place for a certain time period (e.g., 2-3 seconds) for instance, and can include information about the type of turn or motion of the vehicle that has initiated motion. For example, the type of turn or motion of the vehicle that has initiated motion can indicate to the other vehicles an appropriate or defined time period for not initiating motion (e.g., 1 second for straight motion, 2.5 seconds for a turn). The message can specify to the other vehicles to remain in place for a certain amount of time or at least a certain amount of time. In some implementations, the message can specify to each of the other vehicles to remain in place for a respective time amount of time or at least a respective amount of time. In some implementations, the arbitration component 104 can transmit a message to each of the other vehicles, for instance with instructions or information specific to the respective vehicle (e.g., time duration to remain stationary, a time to initiate movement, or specific actions for the respective vehicle, such as to acknowledge receipt of the transmitted message, or to broadcast an announcement when the respective vehicle moves or is about to move).

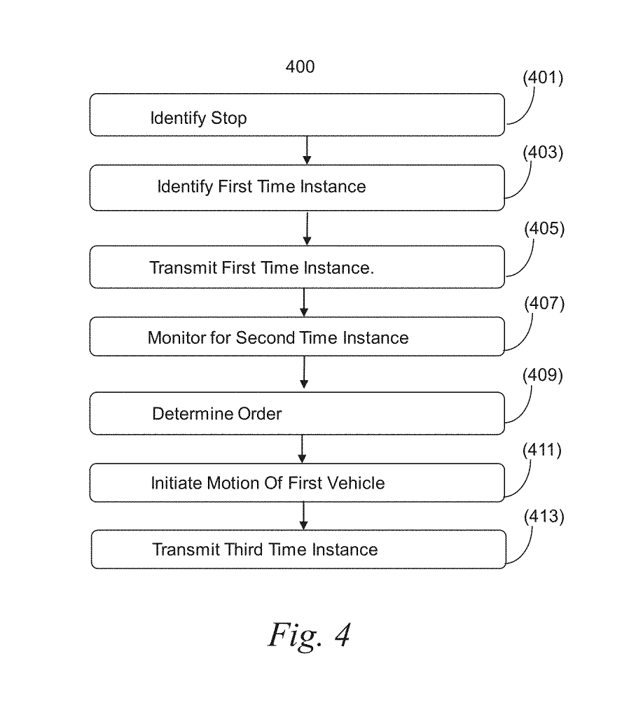

FIG. 4 depicts an example method 400 of communication between vehicles at intersections. The method 400 can include identifying a stop (ACT 401). The method 400 can include identifying a first time instance (ACT 403). The method 400 can include transmitting the first time instance (ACT 405). The method 400 can include monitoring for a second time instance (ACT 407). The method 400 can include determining an order (ACT 409). The method 400 can include initiating motion of a first vehicle 101 (ACT 411). The method 400 can include transmitting a third time instance (ACT 413).

The method 400 can include initiating by a first vehicle 101 a stop at an intersection. The method 400 can include initiating, by an arbitration component of the first vehicle (e.g., by sending one or more instructions to ECU(s) 116 of the first vehicle 101, to control brakes or transmission of the first vehicle for instance), a stop by the first vehicle 101 from motion at an all-way stop, responsive to detection of the all-way stop by the arbitration component. The arbitration component can detect the all-way stop using at least one of a sensor component, map data, and a position of the first vehicle 101 according to the positioning component 105. For instance, the arbitration component can instruct or control the sensor 110 (e.g., front-facing camera) to acquire one or more images around the first vehicle 101, and can instruct or control the ECU(s) 116 of the first vehicle 101 to process the acquired image(s) to perform object recognition or feature detection to determine or detect that an intersection 200 is present or approaching. The arbitration component can compare, check or confirm this determination or detection against stored map data of the first vehicle 101. The arbitration component can detect or confirm the presence of the intersection 200 or all-way stop using a positioning component 105 of the first vehicle 101 and stored map data. For example, the arbitration component can use a GPS device to determine a location of the host vehicle relative to an intersection, using map data that includes an indication of the intersection for instance. The GPS device can use the map data to determine that the host vehicle is approaching or has reached the intersection, e.g., reached a “stop” marker on a street at which the vehicle should halt.

The arbitration component 104 can detect the all-way stop using a sensor 110 of the first vehicle 101, e.g., to image an area in front of or around the first vehicle 101, to identify a feature of the intersection 200. The sensor 110 can for example acquire one or more images at the all-way stop or intersection 200, which can be processed (e.g., by an onboard ECU 116) using image processing and object recognition to identify or detect features indicative of an intersection 200, e.g., a stop sign or surface markings on a street/road. The arbitration component 104 or an onboard ECU 116 can perform object recognition on an acquired image to identify a feature of the all-way stop. The sensor 110 can additionally or alternatively include any of the types of sensors described herein (e.g., V2I, LIDAR, RFID) to detect the intersection 200. The sensor 110 can also detect (e.g., using motion sensing, imaging or any of the other sensing capabilities described herein) whether any other vehicle (e.g., second vehicle 102) is present at or approaching the intersection 200, and can track any such vehicle's position or movement over time for instance. In some implementations, the arbitration component 104 can use any one or a combination of map data 114, the positioning component 105 or the sensor 110 to detect, determine or confirm an approaching intersection, and to detect, determine or confirm a time or spot to stop the first vehicle 101.

The arbitration component 104 can decrease the speed of the first vehicle 101 and make a stop at the intersection 200 by using, activating, controlling or managing one or more onboard ECUs. For example, the one or more onboard ECUs 116 (e.g., a BCM or TCM) can be controlled to apply a brake, switch between gears, adjust the first vehicle's transmission, etc., to allow the first vehicle 101 to come to a stop at the all-way stop, from its motion.

The method 400 can include identifying a stop (ACT 401). The method 400 can include identifying a stop condition of the first vehicle at a road condition that includes an intersection 200 such as an all-way stop. The road condition can include any other situation or vehicular travel or navigation condition for a vehicle that for instance involves a stop before proceeding through the road condition. The road condition can for example include possible or known obstructed pathway(s), low visibility condition(s), converging traffic, etc. A stop condition can include or describe a vehicle (e.g., the first vehicle 101) initiating, entering into, or completing a stop, or while at stop or staying or remaining in a same location or position, for instance at or before proceeding through a road condition. By way of illustration, identifying a stop condition of the first vehicle at a road condition can mean or correspond to identifying or detecting that the first vehicle has completed a stop at an all-way stop.

The method 400 can include identifying a first time instance (ACT 403). The method 400 can include identifying a first time instance that corresponds to the stop condition. The first time instance can be identified based on a time source 106 of the positioning component 105. By way of illustration, determining the first time instance can correspond to determining an instance at which the stop is completed for the first vehicle 101. The method 400 can include determining, using a time source 106 of a positioning component 105 of the first vehicle 101, a first time instance at which the first vehicle 101 completed the stop at the all-way stop or road condition. The arbitration component 104 can use the time source 106 of the positioning component 105 to determine or identify the time instance at which the first vehicle 101 completed the stop at the intersection. The arbitration component 104 can for instance obtain the time instance from a clock or timing signal of the time source 106 at the instance of the first vehicle 101 completing the stop (e.g., as detected by a sensor 110). The positioning component 105 can be satellite based, e.g., include any device based on Global Navigation Satellite System (GNSS), which can include GPS, GLONASS, Galileo, Beidou and other regional systems. The time source 106 can include a device that generates, provides or is synchronized to a time reference obtained from the positioning component 105. The time source 106 can correspond to timing or time reference obtained from the GPS satellite positioning system for example. The time source 106 can use timing signals from a satellite to provide time that is accurate to sub-microsecond levels or even to picoseconds for example. The arbitration component 104 can thus determine a time instance at which the first vehicle 101 completed the stop at the intersection 200, to an accuracy of at least less than a microsecond. Each vehicle (e.g., the first vehicle 101 and the second vehicle 102) hosting its own time source 106 would also be synchronized to an accuracy level below a microsecond between themselves. The time source 106 of the positioning component 105 can thus provide a time reference for the first vehicle 101 that is synchronized with a time reference for another vehicle (e.g., the second vehicle 102) at the intersection 200.

The method 400 can include transmitting the first time instance (ACT 405). The method 400 can include broadcasting or transmitting, via the transceiver, a first message or a first data transmission (e.g., first stop instance data transmission 315) from the first vehicle 101 at the all-way stop, the data transmission indicating the first time instance. The first data transmission can include one or more messages formatted according to any of the communication protocol (e.g., cellular based protocol) described herein. The method 400 can include broadcasting (periodically or otherwise), by the arbitration component 104 via the transceiver 108, a first message comprising the first time instance at which the first vehicle 101 completed the stop at the all-way stop or road condition. The arbitration component 104 can send instruction(s) to the transceiver 108 to perform the first data transmission (e.g., of the first message), for instance as described in accordance with at least FIG. 3. The first message can include an identifier of the first vehicle 101, or a position of the first vehicle 101. The arbitration component 104 can use or instruct a transceiver 108 of the first vehicle 101 to send or broadcast a message comprising a time instance at which the first vehicle 101 completed the stop at an all-way stop or road condition. The transceiver 108 can send a message to other vehicle(s) (e.g., second vehicle 102) wirelessly using any one or more of the communications protocols described herein. The transceiver 108 can send a message to another vehicle (e.g., second vehicle 102) using a direct peer-to-peer (P2P) connection, or through a communication network 118. The transceiver 108 can send the message as a broadcast to a plurality of vehicles in the vicinity (e.g., at or around the intersection), or as a message addressed to identified vehicle(s).

The method 400 can include monitoring for a second time instance (ACT 407). The method 400 can include monitoring for a second time instance that indicates a stop condition of a second vehicle at the all-way stop to identify a monitored result. For instance, the data processing system 103 or arbitration component 104 can instruct the transceiver 108 to detect, receive or monitor for any data transmission or message (e.g., second message or second stop instance data transmission 335) in a specific format or communication protocol. The arbitration component 104 can instruct the ECU(s) 116 to process any detected or received data transmission or message to identify or detect a second time instance included in the data transmission or message. The arbitration component 104 can determine, for instance via feedback or lack of feedback from the transceiver 108 within a defined time period (e.g., 0.5 or 0.2 second) for example, that there is no detected or received data transmission or message from any other vehicle at the intersection 200. The identified monitored result can include any detected or received data transmission or message, or the lack or absence of detected or received data transmission, as described herein. The identified monitored result can include the identified or detected second time instance included in a detected or received data transmission or message.

The method 400 can include detecting a second time instance at which a second vehicle 102 completed a stop. The method 400 can include detecting, by the arbitration component 104 of the first vehicle 101 using the transceiver 108 of the first vehicle 101, a second message (e.g., second stop instance data transmission 335) comprising a second time instance at which a second vehicle 102 completed a stop at the all-way stop or road condition. The arbitration component 104 of the first vehicle 101 can receive or detect, using the transceiver 108, a message (e.g., second message) comprising a time instance (e.g., second time instance) at which another vehicle (e.g., second vehicle 102) completed a stop at the intersection 200. The second time instance can be detected or determined in a manner similar to that described in connection with ACT 403. The arbitration component 104 of the first vehicle 101 can be configured to wait for such a message from each vehicle detected at the intersection. For instance, the arbitration component 104 can use the sensor 110 or a V2V sensor of the first vehicle 101 to detect or determine the number of vehicles at the intersection, and can wait to receive such a message from each of the detected vehicle. If any of the messages do not arrive within a certain time period (e.g., 0.3 or 0.5 second), the arbitration component 104 of the first vehicle 101 can retransmit the first time instance for example (e.g., until all expected messages are received).

The method 400 can include determining an order (ACT 409). The method can include comparing, using the arbitration component 104, the first time instance to the monitored result to determine an order of passage through the road condition or all-way stop. The arbitration component 104 of the first vehicle 101 can compare time instances at which the first vehicle 101 and other vehicle(s) (e.g., second vehicle 102) completed their stops at the intersection 200. The arbitration component 104 can compare (e.g., instruct an onboard processor or the ECU(s) 116 to compare) the first time instance and the second time instance (e.g., the monitored result) to determine which is temporally earlier, to establish priority of the respective vehicles. For instance, the arbitration component 104 of the first vehicle 101 can identify the monitored result wherein the monitored result indicates the second time instance, and determine that the first time instance occurred before the second time instance. The arbitration component 104 of the first vehicle 101 (and that of the first vehicle 102) can determine a temporal order of vehicles completing their stops at the intersection, and determine a corresponding order, hierarchy or sequence for the vehicles to initiate motion to pass into or through the intersection, based on the priority or temporal order. For instance, a vehicle (e.g., first vehicle 101) that completed its stop prior to other vehicles can initiate motion from the intersection ahead of the other vehicles (e.g., second vehicle 102). The arbitration component 104 can assign a turn or time for each vehicle to move or pass into or through the intersection, according to the sequence or times at which the vehicles completed their stops. The arbitration component 104 can initiate motion of the first vehicle 101 from the intersection 200, according to the order, hierarchy, sequence or assigned turn/time.

When, for example, two or more vehicles record the same time instance, the arbitration component 104 (e.g., of either vehicle) can apply one or more arbitration rules to establish an order for these vehicles. For example, the arbitration component 104 can order or prioritize the vehicles based on their vehicle identifiers (or other identifiers such as onboard device identifiers, license plate identifiers), presence/location of pedestrians crossing or intending to cross the intersection, or priorities established for each approaching direction of the intersection 200. Accordingly, the arbitration component 104 of each vehicle can systematically assign a turn or time for each vehicle to proceed from the intersection 200.

The method 400 can include initiating motion of a first vehicle 101 (ACT 411). The method can include providing, based on the order of passage through the road condition, an instruction (e.g., a second vehicle command instruction 345) from the arbitration component 104 to the one or more ECUs 116 to initiate motion of the first vehicle 101 through the road condition. The method 400 can include initiating motion of the first vehicle 101 from, into or through the intersection 200, all-way stop or road condition. The method 400 can include initiating, by the arbitration component 104 based on at least a comparison of the first time instance and the second time instance, motion of the first vehicle 101 from the all-way stop or road condition.

The arbitration component 104 can, in communication with the sensor 110 of the first vehicle 101, use motion detection or imaging and object recognition for instance (using the sensor 110 and the ECU(s) 116 for instance), to confirm that any other vehicle (e.g., second vehicle 102) at the intersection are stationary, before initiating motion of the first vehicle 101. The arbitration component 104 can initiate (e.g., via the one or more ECUs 116) motion of the first vehicle 101 from the all-way stop or through the road condition responsive to the confirmation. Any such imaging and object recognition can be limited to a defined time period (e.g., 1 or 0.5 seconds, or other time duration prior to initiating movement), to limit the amount of image processing, and to limit the amount of time or delay in keeping the first vehicle 101 at the intersection 200. The motion detection or imaging and object recognition can occur while the arbitration component 104 is transmitting the first vehicle's stop time or determining the order of vehicles for instance, so as to minimize the first vehicle's overall halt time at the intersection.

For example, the arbitration component 104 can determine that the first time instance occurred before the second time instance. The arbitration component 104 can authorize, responsive to the determination that the first time instance occurred before the second time instance, the first vehicle 101 to initiate motion from the all-way stop or through the road condition (including the all-way stop) prior to initiating motion of the second vehicle 102 through the road condition. As another example, the arbitration component 104 can determine that the first time instance occurred after the second time instance. The arbitration component 104 can prevent, responsive to the determination that the first time instance occurred after the second time instance, the initiation of the motion of the first vehicle 101 through the road condition, until at least one of: the second vehicle 102 has initiated motion through the road condition (e.g., from or through the all-way stop), and at least a period of time has elapsed. For instance, the arbitration component 104 can detect, using the transceiver 108 when the first vehicle 101 is stopped at the all-way stop, a fourth message comprising a fourth time instance at which motion of the second vehicle 102 is initiated through the road condition. The arbitration component 104 can maintain, responsive to the fourth message, a position of the first vehicle 101 position at the all-way stop for at least a defined period of time.

In yet another example, the arbitration component 104 can determine that the first time instance occurred after the second time instance. The arbitration component 104 can authorize, responsive to the determination that the first time instance occurred after the second time instance, the initiation of the motion of the first vehicle 101 through the road condition after the second vehicle 102 has initiated motion through the road condition. By way of another example, the arbitration component 104 can receive a notification from the second vehicle 102 indicating that the second vehicle 102 is delaying motion from the all-way stop. The arbitration component 104 can authorize, responsive to the notification, the initiation of the motion of the first vehicle 101 through the road condition prior to initiation of motion of the second vehicle 102 through the road condition.

The method 400 can include transmitting a third time instance (ACT 413). The method 400 can include broadcasting, via the transceiver 108, a second data transmission (e.g., start instance data transmission 355, or third message) that includes a third time instance that corresponds to the initiation of the motion of the first vehicle 101 through the road condition. The third time instance can be identified based on the time source 106 of the positioning component 105. The method 400 can include transmitting a third time instance at which the first vehicle 101 initiated motion from or through the intersection 200 or road condition. The method 400 can include broadcasting, by the arbitration component 104, a third message comprising a third time instance at which the first vehicle 101 initiated motion from or through the road condition or all-way stop.

The transceiver 108 can broadcast or send the second data transmission, wherein the second data transmission provides an indication to delay the initiation of the motion of the second vehicle 102 through the road condition. The third message can be broadcasted to prevent any vehicle stopped at the all-way stop at the third time instance from initiating motion for at least a predefined period of time. The third message or the second data transmission can include an indication that the first vehicle 101 is initiating at least one of a turn and a forward motion from or through the all-way stop or road condition. The third time instance can be determined using the time source 106 of the positioning component 105. For example, the arbitration component 104 can obtain a time instance from the time source 106, corresponding to the instance in which the arbitration component 104 instructed the ECU(s) 116 to initiate motion of the first vehicle 101, or corresponding to the instance that the sensor 110 sensed the start of motion of the first vehicle 101. The arbitration component 104 can transmit or broadcast the third message with the time instance at which the first vehicle 101 initiated motion from the intersection, to prevent any other vehicle stopped at the intersection from initiating motion (e.g., for at least a predefined period of time from the time instance).

The third message can be used to notify or warn the other vehicles (e.g., second vehicle 102), so as to avoid multiple vehicles from traversing the intersection at such proximity relative to each other as to potentially cause an accident or collision. The message can instruct the other vehicles (e.g., second vehicle 102) to remain stopped, stationary or in place for a certain time period (e.g., 2-3 seconds) for instance, and can include information about the type of turn or motion of the vehicle that has initiated motion. For example, the type of turn or motion of the vehicle that has initiated motion (e.g., first vehicle 101) can indicate to the other vehicles (e.g., second vehicle 102) an appropriate or defined time period for not initiating motion (e.g., 1 second for straight motion, 2.5 seconds for a turn). The message can specify to the other vehicles (e.g., second vehicle 102) to remain in place for a certain amount of time or at least a certain amount of time. In some implementations, the message can specify to each of the other vehicles to remain in place for a respective time amount of time or at least a respective amount of time. In some implementations, the arbitration component transmits a message to each of the other vehicles (e.g., second vehicle 102, and so on), for instance with instructions or information specific to the respective vehicle (e.g., time duration to remain stationary or a time to initiate movement).

By way of a non-limiting example, the transceiver can receive, using a cellular based communication protocol or otherwise, the second message comprising the second time instance. The arbitration component 104 can attempt to confirm that the second vehicle 102 has indeed stopped at the all-way stop. The arbitration component 104 can determine if the second vehicle 102 has stopped at the all-way stop at a time instance consistent with the second time instance. For example, the arbitration component 104 can, in communication with the sensor 110 of the first vehicle 101, use imaging and object recognition, with timing information provided by the time source, to determine that the second vehicle 102 has stopped at the all-way stop at a time instance consistent with the second time instance. The arbitration component 104 can compare the first time instance and the second time instance responsive to determining that the second vehicle 102 has stopped at the all-way stop at a time instance consistent with the second time instance. The arbitration component 104 can initiate, based on at least the comparison of the first time instance and the second time instance, motion of the first vehicle 101 from the all-way stop.

By way of another non-limiting example, the transceiver 108 can receive a message via different communication protocols. The transceiver 108 can for instance receive the second message in a first format using a cellular based communication protocol, and concurrent with or within a length of time of receiving the second message in the first format, receive the second message in a second format using near field communication (NFC). The arbitration component 104 can compare, validate or confirm the second time instance based on the second message received in the first format and the second message received in the second format. The arbitration component 104 can compare the first time instance and the second time instance responsive to the validation. The arbitration component 104 can initiate, based on at least the comparison of the first time instance and the second time instance, motion of the first vehicle 101 from the all-way stop or through the road condition.

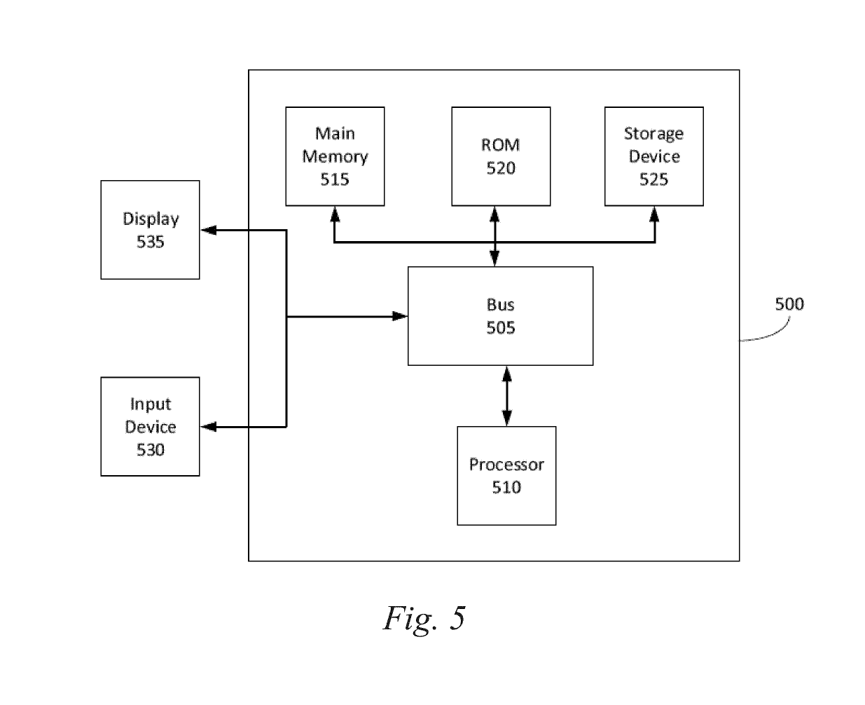

FIG. 5 is a block diagram of an example computer system 500. The computer system or computing device 500 can include or be used to implement the data processing system 103, or its components such as the data processing system 103. The computing system 500 includes at least one bus 505 or other communication component for communicating information and at least one processor 510 or processing circuit coupled to the bus 505 for processing information. The computing system 500 can also include one or more processors 510 or processing circuits coupled to the bus for processing information. The computing system 500 also includes at least one main memory 515, such as a random access memory (RAM) or other dynamic storage device, coupled to the bus 505 for storing information, and instructions to be executed by the processor 510. The main memory 515 can be or include the memory 112. The main memory 515 can also be used for storing position information, vehicle information, command instructions, vehicle status information, environmental information within or external to the vehicle, road status or road condition information, or other information during execution of instructions by the processor 510. The computing system 500 may further include at least one read only memory (ROM) 520 or other static storage device coupled to the bus 505 for storing static information and instructions for the processor 510. A storage device 525, such as a solid state device, magnetic disk or optical disk, can be coupled to the bus 505 to persistently store information and instructions. The storage device 525 can include or be part of the memory 112.

The computing system 500 may be coupled via the bus 505 to a display 535, such as a liquid crystal display, or active matrix display, for displaying information to a user such as a driver of the first vehicle 101 or the second vehicle 102. An input device 530, such as a keyboard or voice interface may be coupled to the bus 505 for communicating information and commands to the processor 510. The input device 530 can include a touch screen display 535. The input device 530 can also include a cursor control, such as a mouse, a trackball, or cursor direction keys, for communicating direction information and command selections to the processor 510 and for controlling cursor movement on the display 535. The display 535 (e.g., on a vehicle dashboard) can be part of the data processing system 103, the sensor 110, or other component of FIG. 1, as well as part of the vehicle external to the data processing system 103, for example.

The processes, systems and methods described herein can be implemented by the computing system 500 in response to the processor 510 executing an arrangement of instructions contained in main memory 515. Such instructions can be read into main memory 515 from another computer-readable medium, such as the storage device 525. Execution of the arrangement of instructions contained in main memory 515 causes the computing system 500 to perform the illustrative processes described herein. One or more processors in a multi-processing arrangement may also be employed to execute the instructions contained in main memory 515. Hard-wired circuitry can be used in place of or in combination with software instructions together with the systems and methods described herein. Systems and methods described herein are not limited to any specific combination of hardware circuitry and software.

Although an example computing system has been described in FIG. 5, the subject matter including the operations described in this specification can be implemented in other types of digital electronic circuitry, or in computer software, firmware, or hardware, including the structures disclosed in this specification and their structural equivalents, or in combinations of one or more of them.

Some of the description herein emphasizes the structural independence of the aspects of the system components (e.g., arbitration component), and the positioning component 105 and map data illustrates one grouping of operations and responsibilities of these system components. Other groupings that execute similar overall operations are understood to be within the scope of the present application. Modules can be implemented in hardware or as computer instructions on a non-transient computer readable storage medium, and modules can be distributed across various hardware or computer based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. For example, a reference to “at least one of” ‘A’ and 13′ can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

The systems and methods described herein may be embodied in other specific forms without departing from the characteristics thereof. Scope of the systems and methods described herein is thus indicated by the appended claims, rather than the foregoing description, and changes that come within the meaning and range of equivalency of the claims are embraced therein.

What is claimed is:

1. A system of inter-vehicle communication to navigate road conditions, comprising:
a data processing system of a first vehicle, the data processing system comprising an arbitration component, a positioning component, a transceiver, and one or more electronic control units (ECUs), the data processing system to:
identify a stop condition of the first vehicle at a road condition that includes an all-way stop, and a first time instance that corresponds to the stop condition, the first time instance identified based on a time source of the positioning component;
broadcast, via the transceiver, a first data transmission from the first vehicle at the all-way stop, the data transmission indicating the first time instance;
monitor for a second time instance that indicates a stop condition of a second vehicle at the all-way stop to identify a monitored result;
compare, using the arbitration component, the first time instance to the monitored result to determine an order of passage through the road condition;
provide, based on the order of passage through the road condition, a motion command from the arbitration component to the one or more ECUs to initiate motion of the first vehicle through the road condition; and
broadcast, via the transceiver, a second data transmission that includes a third time instance that corresponds to the initiation of the motion of the first vehicle through the road condition, the third time instance identified based on the time source of the positioning component.

2. The system of claim 1, comprising the data processing system to:
broadcast, via the transceiver, the second data transmission, wherein the second data transmission provides an indication to delay the initiation of the motion of the second vehicle through the road condition.

3. The system of claim 1, comprising the data processing system to:
identify the monitored result, wherein the monitored result indicates the second time instance; and
determine that the first time instance occurred before the second time instance.

4. The system of claim 1, comprising the data processing system to:
detect the all-way stop using at least one of a sensor, map data, and the positioning component.

5. The system of claim 1, comprising the data processing system to:
acquire an image using a sensor; and
perform, using the one or more ECUs, object recognition on the acquired image to identify a feature of the all-way stop.

6. The system of claim 1, comprising the time source of the positioning component to provide a time reference for the first vehicle synchronized with a time reference for the second vehicle.

7. The system of claim 1, wherein the positioning component comprises a satellite based positioning component.

8. The system of claim 1, comprising the data processing system to:
receive, via the transceiver, a message comprising the second time instance using a cellular based communication protocol; and
use imaging and object recognition to determine that the second vehicle has stopped at the all-way stop at a time instance consistent with the second time instance;
compare, using the arbitration component, the first time instance and the second time instance responsive to determining that the second vehicle has stopped at the all-way stop at a time instance consistent with the second time instance; and
initiate, via the one or more ECUs based on at least the comparison of the first time instance and the second time instance, the motion of the first vehicle through the road condition.

9. The system of claim 1, comprising the data processing system to:
receive, via the transceiver, a message comprising the second time instance transmitted in a first format using a cellular based communication protocol,
receive, via the transceiver, concurrent with or within a length of time of receiving the message in the first format, a message comprising the second time instance transmitted in a second format using near field communication (NFC);
validate, using the arbitration component, the second time instance based on the message received in the first format and the second received in the second format;
compare, using the arbitration component, the first time instance and the second time instance responsive to the validation; and
initiate, via the one or more ECUs based on at least the comparison of the first time instance and the second time instance, the motion of the first vehicle through the road condition.

10. The system of claim 1, comprising the data processing system to:
use imaging and object recognition to confirm that any other vehicle at the all-way stop are stationary; and
initiate, via the one or more ECUs, the motion of the first vehicle through the road condition responsive to the confirmation.

11. The system of claim 1, comprising the data processing system to:
determine, using the arbitration component, that the first time instance occurred before the second time instance; and
authorize, responsive to the determination that the first time instance occurred before the second time instance, the initiation of the motion of the first vehicle through the road condition, prior to initiating motion of the second vehicle through the road condition.

12. The system of claim 1, comprising the data processing system to:
determine, using the arbitration component, that the first time instance occurred after the second time instance; and
prevent, responsive to the determination that the first time instance occurred after the second time instance, the initiation of the motion of the first vehicle through the road condition, until at least one of: the second vehicle has initiated motion through the road condition, and at least a period of time has elapsed.

13. The system of claim 1, comprising the data processing system to:
determine, using the arbitration component, that the first time instance occurred after the second time instance; and
authorize, responsive to the determination that the first time instance occurred after the second time instance, the initiation of the motion of the first vehicle through the road condition after the second vehicle has initiated motion through the road condition.

14. The system of claim 1, comprising the data processing system to:
receive, via the transceiver, a notification from the second vehicle that the second vehicle is delaying motion from the all-way stop; and
authorize, responsive to the notification, the initiation of the motion of the first vehicle through the road condition prior to initiation of motion of the second vehicle through the road condition.

15. The system of claim 1, comprising the data processing system to:
receive, via the transceiver when the first vehicle is in the stop condition, a fourth message comprising a fourth time instance at which motion of the second vehicle is initiated through the road condition; and
maintain, responsive to the fourth message, a position of the first vehicle at the all-way stop for at least a defined period of time.

16. The system of claim 1, wherein the second data transmission comprises an indication that the first vehicle is initiating at least one of a turn and a forward motion from the all-way stop.

17. A method of inter-vehicle communication to navigate road conditions, comprising:
identifying a stop condition of the first vehicle at a road condition that includes an all-way stop;
identify, based on a time source of a positioning component of the first vehicle, a first time instance that corresponds to the stop condition, the first time instance identified;
broadcasting, by a transceiver of the first vehicle, a first data transmission from the first vehicle at the all-way stop, the data transmission indicating the first time instance;
monitoring for a second time instance that indicates a stop condition of a second vehicle at the all-way stop to identify a monitored result;
comparing, by an arbitration component of the first vehicle, the first time instance to the monitored result to determine an order of passage through the road condition;
providing, by the arbitration component based on the order of passage through the road condition, a motion command to one or more ECUs of the first vehicle to initiate motion of the first vehicle through the road condition; and
broadcasting, by a transceiver, a second data transmission that includes a third time instance that corresponds to the initiation of the motion of the first vehicle through the road condition, the third time instance identified based on the time source of the positioning component.

18. The method of claim 17, comprising the data processing system to:
broadcast, via the transceiver, the second data transmission, wherein the second data transmission provides an indication to delay the initiation of the motion of the second vehicle through the road condition.

19. The method of claim 17, comprising:
identifying the monitored result, wherein the monitored result indicates the second time instance; and
determining, by the arbitration component, that the first time instance occurred before the second time instance.

20. The method of claim 17, comprising:
detecting the all-way stop using at least one of a sensor of the first vehicle, map data, and the positioning component.
